(19) United States
(12) Patent Application Publication
(10) Pub. No.: US 2012/0041955 A1
(43) Pub. Date: Feb. 16, 2012

(54) ENHANCED IDENTIFICATION OF DOCUMENT TYPES

(75) Inventors: Yizhar Regev, Ramat Gan (IL); Gilad Weiss, Kfar Saba (IL)

(73) Assignee: NOGACOM LTD., Herzliya (IL)

(21) Appl. No.: 12/853,310

(22) Filed: Aug. 10, 2010

(51) Int. Cl. G06F 17/30

(52) U.S. Cl. 707/740; 707/E17.089; 707/737

(57) ABSTRACT

A method for document management includes automatically extracting respective features from each of a set of documents. The features are processed in a computer so as to generate respective vectors for the documents, each vector including elements having respective values that represent properties of a respective document. A similarity between the documents is assessed by computing a measure of distance between the respective vectors. The documents are automatically clustered responsively to the similarity so as to identify a cluster of the documents belonging to a common document type. Similar methods may be used in supervised categorization, wherein documents are compared and categorized based on a training set that is prepared for each document type.

### FIELD OF THE INVENTION

The present invention relates generally to information processing, and specifically to methods and systems for document management.

### BACKGROUND OF THE INVENTION

Most business and technical documents today are written, edited and stored electronically. Organizations commonly deal with vast numbers of documents, many in the form of natural language text (also known as “free text”). The documents relate to a wide range of topics and have a large variety of formats and functions, such as financial statements, contracts, internal procedures, business letters, forms, and so forth. Such documents may be distributed and used across the organization, and located physically in various systems and repositories.

### SUMMARY

Embodiments of the present invention that are described hereinbelow provide improved methods and system for automated processing of electronic documents, and particularly for extracting document features and classifying document types.

There is therefore provided, in accordance with an embodiment of the present invention, a method for document management, which includes automatically extracting respective features from each of a set of documents. The features are processed in a computer so as to generate respective vectors for the documents, each vector including elements having respective values that represent properties of a respective document. A similarity between the documents is assessed by computing a measure of distance between the respective vectors. The documents are automatically clustered responsively to the similarity so as to identify a cluster of the documents belonging to a common document type.

In some embodiments, processing the features includes generating a string corresponding to the vector, wherein the elements of the vector include respective characters in the string. Automatically extracting the respective features may include parsing a hierarchical tree representation of each of the documents, and building the string to represent the tree by recursively traversing the nodes of the tree and adding the characters to the string so as to represent the traversed nodes. Additionally or alternatively, generating the string may include, when the string exceeds a predetermined length, truncating the string to the predetermined length by selecting a first sequence of the characters from a beginning of the string and concatenating it with a second sequence of the characters from an end of the string. Further additionally or alternatively, computing the measure of distance may include computing a string distance between strings representing the respective vectors.

Typically, at least some of the elements of the vectors include symbols that represent respective ranges of values of the properties. Automatically extracting the respective features may include identifying format features of the documents, wherein the elements of the vectors represent respective characteristics of the format.

There is also provided, in accordance with an embodiment of the present invention, a method for document management, which includes receiving respective file names of a plurality of documents. Each file name is processed in a computer so as to divide the file name into a sequence of sub-tokens, and respective weights are assigned to the sub-tokens. A similarity between the documents is assessed by computing a measure of distance between the respective file names based on the sub-tokens in each of the file names and on the respective weights of the sub-tokens. The documents are automatically clustered responsively to the similarity so as to identify at least one cluster of the documents belonging to a common document type.

In some embodiments, processing each file name includes separating the file name into alpha, numeric, and symbol sub-tokens. Typically, each alpha sub-token consists of a sequence of letters, each having a respective case, such that the case does not change from lower case to upper case within the sequence. Additionally or alternatively, assigning the respective weights includes assigning a greater weight to the alpha sub-tokens than to the numeric and symbol sub-tokens. Further additionally or alternatively, assigning the respective weights includes assigning a greater weight to acronyms than to other sub-tokens.

In some embodiments, computing the measure of the distance includes computing a weighted sum of sub-token distances between the sub-tokens of a first document and corresponding sub-tokens of a second document, wherein the sub-token distances are weighted by the respective weights of the sub-tokens. In a disclosed embodiment, computing the weighted sum includes aligning each of the sub-tokens of the first document with a first corresponding sub-token of the second document in a forward order in order to compute a first weighted distance, and aligning each of the sub-tokens of the first document with a second corresponding sub-token of the second document in a reverse order in order to compute a second weighted distance, and combining the first and second weighted distances in order to find the measure of the distance between the respective file names.

There is additionally provided, in accordance with an embodiment of the present invention, a method for document management, which includes automatically identifying respective embedded objects in each of a set of documents. The embedded objects are processed in a computer so as to extract respective embedded object features of the documents, wherein the embedded object features are indicative of format characteristics of the embedded objects in the documents. A similarity between the documents is assessed by computing a measure of distance between the documents based on the respective embedded object features. The documents are automatically clustered responsively to the similarity so as to identify a cluster of the documents belonging to a common document type.

Typically, the embedded object features include a respective shape of each of the embedded objects. Computing the measure of the distance may include aligning each of the embedded objects in a first document with a corresponding embedded object in a second document, and computing an association score between the aligned embedded objects.

There is further provided, in accordance with an embodiment of the present invention, a method for document management, which includes automatically extracting headings from each of a set of documents. The headings are processed in a computer so as to generate respective heading features of the documents. A similarity between the documents is assessed by computing a measure of distance between the documents based on the respective heading features. The documents are automatically clustered responsively to the similarity so as to identify a cluster of the documents belonging to a common document type.

In some embodiments, automatically extracting the headings includes distinguishing the headings from paragraphs of text with which the headings are associated in the documents. Typically, distinguishing the headings includes assigning respective heading scores to the headings, indicating a respective level of confidence in each of the headings, and processing the headings includes choosing the headings for inclusion in the heading features responsively to the respective heading scores. Computing the measure may include computing a weighted sum of association scores between the headings, weighted by the heading scores.

In a disclosed embodiment, processing the headings includes extracting format characteristics of the headings, and generating a heading style feature based on the format characteristics. Additionally or alternatively, processing the headings includes extracting textual content from the headings, and generating a heading text feature based on the textual content. Computing the measure of the distance may include computing a heading text distance responsively to the textual content and computing a heading style distance responsively to format characteristics of the headings.

Alternatively or additionally, computing the measure of the distance includes aligning each of the headings in a first document with a corresponding heading in a second document, and computing an association score between the aligned headings.

There is moreover provided, in accordance with an embodiment of the present invention, a method for document management that includes providing respective training sets including known documents belonging to each of a plurality of document types. Respective features are automatically extracting respective features from the known documents and from each of a set of new documents. The features are processed in a computer so as to generate respective vectors for the documents, each vector including elements having respective values that represent properties of a respective document. A similarity between the new documents and the known documents in each of the training sets is assessed by computing a measure of distance between the respective vectors. The new documents are automatically categorized with respect to the document types responsively to the similarity. The categorization is binary, i.e., for any given type, a new document is categorized as either belonging or not belonging to that type.

There is furthermore provided, in accordance with an embodiment of the present invention, apparatus including an interface, which is coupled to access documents in one or more data repositories, and a processor configured to carry out the methods described above.

There are additionally provided, in accordance with an embodiment of the present invention, computer software products, including a computer-readable medium in which program instructions are stored, which instructions, when read by a computer, cause the computer to carry out the methods described above.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for document management, in accordance with an embodiment of the present invention;

FIG. 2 is a graph that schematically illustrates a hierarchy of document types, in accordance with an embodiment of the present invention;

FIG. 3 is a flow chart that schematically illustrates a method for clustering documents by type, in accordance with an embodiment of the present invention;

FIG. 4 is a flow chart that schematically illustrates a method for extracting and comparing file name features, in accordance with an embodiment of the present invention;

FIG. 5 is a flow chart that schematically illustrates a method for extracting and comparing embedded object features, in accordance with an embodiment of the present invention;

FIG. 6 is a flow chart that schematically illustrates a method for extracting and comparing heading features, in accordance with an embodiment of the present invention; and

FIG. 7 is a flow chart that schematically illustrates a method for extracting and representing document structure features, in accordance with an embodiment of the present invention.

### DETAILED DESCRIPTION OF EMBODIMENTS

### Overview

There is an increasing need for tools for document clustering and categorization that can help users find quickly the documents they are seeking in the repositories of the organization to which they belong (for example, “find the contract with Cisco,” or “find last quarter's financial statements”). Although there are many tools known in the art for categorizing and tagging documents by topic (such as politics, business, or science), there is also a need, which is largely unsatisfied at present, for tools that can cluster or categorize documents by their type, meaning the business function and/or format of the documents.

For example, the finance department of an organization uses various documents, all of which share the same topic—finance—but which may differ in their function and format: There may be, for example, procedures, internal forms, external forms, human resources (HR) forms, standard purchase orders, fixed-price purchase orders, executive presentations, financial statements, memos, etc. The division into types is disjoint from the division into topics, i.e., documents of different types may share the same topic, while documents of one type may have different topics. Thus, for instance, a company's set of procedures may include documents belonging to various topics while belonging all to the same type.

Classifying documents by their type can be particularly useful when the user is looking for a specific document among several documents relating to the same topic or business entity. Existing systems for document categorization and clustering rely mainly on document content words, which are usually shared among documents with the same topic, and therefore are not readily capable of categorizing documents by type. Embodiments of the present invention, on the other hand, use other document features in order to cluster and categorize documents not only by content, but also by type.

U.S. patent application Ser. No. 12/200,272, filed Aug. 28, 2008, which is assigned to the assignee of the present patent application and whose disclosure is incorporated herein by reference, describes a classification and search server for use in document type identification. The server retrieves documents from various sources in an organizational network, such as storage repositories, file servers, mail servers, employee and product directories, ERP and CRM systems and other applications. The server extracts three groups of features from each retrieved document:
Content features, based on the textual content of the document.
Format features, based on the document layout, outline and other format parameters.
Metadata features, based on the document metadata.

Based on these features, for each input document, the server retrieves a set of candidate documents, i.e., documents that were processed and type-clustered previously and also have similar features to those of the input document. These documents are candidates in the sense that the server may, after further processing, categorize the input document as being in the same type cluster or clusters as one or more of the candidates. The server may also add to the set of candidate documents other documents that were previously clustered as belonging to the same type as the initial candidate documents. Optionally, the server may take all of the available documents as candidates (although this approach is usually impractical given the large numbers of documents in most organizational data systems).

To determine the best document cluster for a (new) input document, the server computes distance functions, also referred to as distance measures or distance measures, between the input document and each of the candidates, based on the extracted features. It places the document in the best-fitting cluster (i.e., links the document to the cluster), based on a compound aggregation of the distance function values. If required (for example, when the document distance from all candidates exceeds a certain configurable threshold), a new cluster is created. In most cases, however, relevant clusters will have already been defined in the processing of previous input documents, and the server will therefore typically update the clusters by assigning the input document to the cluster (or clusters) that is closest according to the distance functions.

Alternatively, the above-described distance function may be the basis for supervised, training-based categorization. In this case, an experienced user prepares a training set consisting of good examples for each document type. The distance function between each given document and the training set for each type is computed and weighted, resulting in a decision as to whether or not the document belongs to the given document type. If the distance between a document and the training set for a given document type is below a certain predefined threshold, the document is categorized as belonging to that type. Otherwise, the decision would that the document does not belong to that type. Although the description below refers mainly to clustering as a means for determining document types, these same methods may be applied, mutatis mutandis, in supervised categorization.

In the embodiments that were disclosed in U.S. patent application Ser. No. 12/200,272, the clustering (or categorization) is done in three stages:
1. The documents are first clustered based on the content features.
2. The resulting content-based clusters are merged according to the metadata features.
3. The content/metadata-based clusters are merged according to the format features.
   Alternatively, other combinations of features and different orders of clustering stages may be used. The result of the successive clustering stages is a grouping of all processed documents into type clusters. This clustering is also followed by construction of a multi-level hierarchy of clusters of different types and sub-types.

Embodiments of the present invention that are described hereinbelow provide improvements to the basic modes of operation that were described in U.S. patent application Ser. No. 12/200,272. These embodiments relate, inter alia, to the manner in which features of documents are extracted and represented for efficient comparison, as well as to processing of specific sorts of features, including document file names and structure, headings and embedded objects. These format and metadata features have been found to be particularly significant in automatic document type classification. Other features, including features known in the art such as document keywords, may be used, as well, in a similar fashion to the features described below.

### System Description

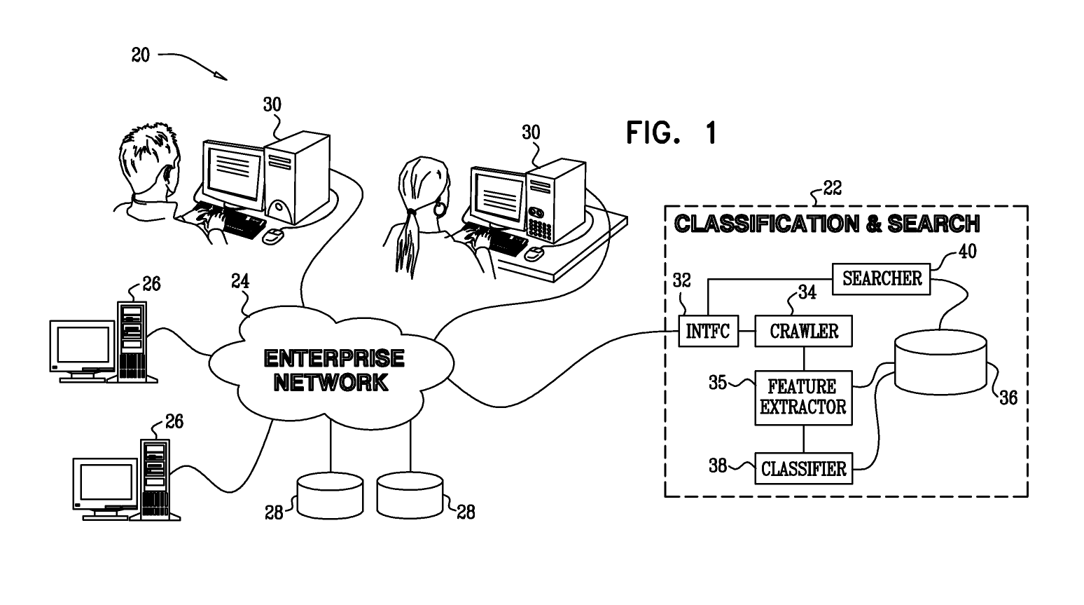

FIG. 1 is a block diagram that schematically illustrates a system 20 for document management, in accordance with an embodiment of the present invention. System 20 is typically maintained by an organization, such as a business, for purposes of exchanging, storing and recalling documents used by the organization. A classification and search server 22 identifies document types and builds a listing, such as an index, for use in retrieving documents by type, as described in detail hereinbelow.

System 20 is typically built around an enterprise network 24, which may comprise any suitable type or types of data communication network, and may, for example, include both intranet and extranet segments. A variety of servers 26 may be connected to the network, including mail and other application servers, for instance. Storage repositories 28 are also connected to the network and may contain documents of different types and formats, which may be held in one or more file systems or in storage formats that are associated with mail severs or other document management systems. Server 22 may use appropriate Application Programming Interfaces (APIs) and file converters to access the documents, as well as document metadata, and to convert the heterogeneous document contents to suitable form for further processing.

Server 22 connects to network 24 via a suitable network interface 32. The server typically comprises one or more general-purpose computer processors, which are programmed in software to carry out the functions that are described herein. This software may be downloaded to server 22 in electronic form, over a network, for example. Alternatively or additionally, the software may be provided on tangible computer-readable storage media, such as optical, magnetic or electronic memory media. Although server 22 is shown in FIG. 1, for the sake of simplicity, as a single unit, in practice the functions of the server may be carried out by a number of different processors, such as a separate processor (or even a separate computer) for each of the functional blocks shown in the figure. Alternatively, some or all of the functional blocks may be implemented simply as different processes running on the same computer. Furthermore, the computer or computers that perform the functions of server 22 may perform other data processing and management functions, as well. All such alternative configurations are considered to be within the scope of the present invention.

Some of the functions of server 22 are described in greater detail with reference to the figures that follow, and others are described in the above-mentioned U.S. patent application Ser. No. 12/200,272. Briefly, server 22 comprises a crawler 34, which collects documents from system 20. Crawler 34 scans the file systems, document management systems and mail servers in system 20 and retrieves new documents, and possibly also documents that have recently been changed or deleted. The documents may include, for example, text documents and spreadsheet documents in various different formats, as well as substantially any other type of document with textual content, including even images and drawings with embedded components. For example, crawler 34 may be configured to retrieve non-text documents, as well as document components that are embedded within other documents. The crawler may be capable of recognizing embedded files and separating them from the documents in which they are embedded.

A feature extractor 35 extracts and stores content, format and metadata features from each input document, as described in detail hereinbelow. A classifier 38 compares the document features in order to cluster the documents by specific types. In addition, after the clusters have been created, a hierarchical document type index is created. Feature extractor 35 and classifier 38 store the document features and type information in an internal repository 36, which typically comprises a suitable storage device or group of such devices. The term “index,” as used in the context of the present patent application, means any suitable sort of searchable listing. The indices that are described herein may be held in a database or any other suitable type of data structure or format.

A searcher 40 receives requests, from users of client computers 30 or from other applications, to search the documents in system 20 for documents of a certain type, or documents belonging to the same type or types as a certain specified document. (The requests typically include other query parameters, as well, such as keywords or names of business objects.) In response to such requests, the searcher consults the type index and provides the requester with a listing of documents of the desired type or types that meet the search criteria. The user may then browse the content and metadata of the documents in the listing in order to find the desired version.

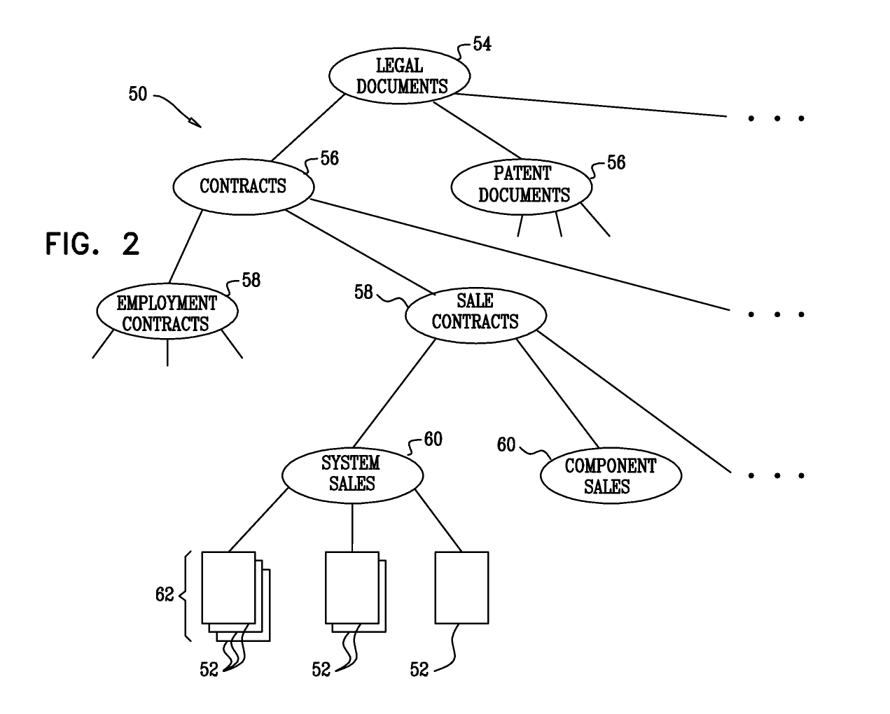

FIG. 2 is a graph that schematically illustrates a hierarchy 50 of document types, which is created by server 22 in accordance with an embodiment of the present invention. The hierarchy classifies documents 52 according to types 54, 56, 58 and 60, wherein each type corresponds to a certain cluster of documents found by the server. Thus, a high-level type 54, such as “legal documents,” will correspond to a large cluster, which sub-divides into clusters corresponding to lower-level types (referred to for convenience as sub-types) 56, such as “contracts,” “patent documents,” and so forth. This hierarchy, however, is shown solely by way of example, and other hierarchies of different kinds, containing larger or smaller numbers of levels, may likewise be defined.

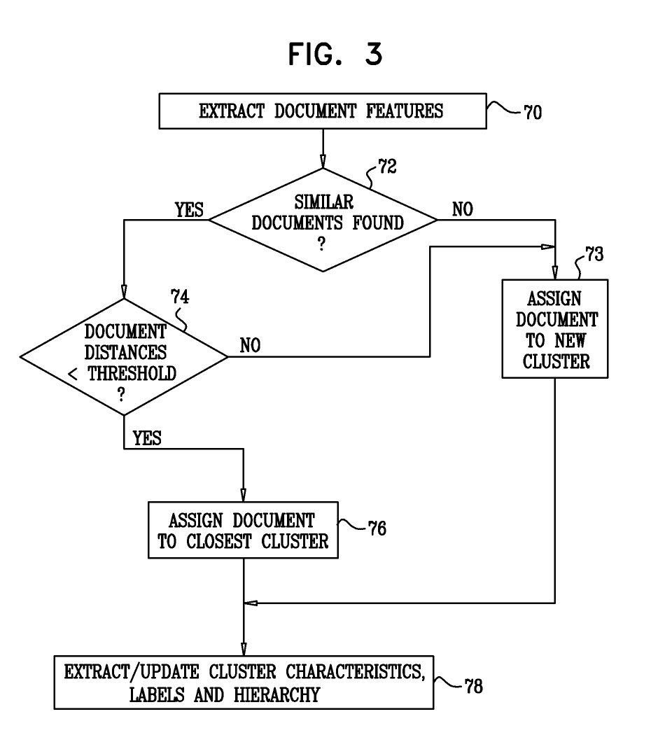

A hierarchy of the type shown in FIG. 2 is typically built from the bottom up, as explained hereinbelow with reference to FIG. 3. Server 22 first arranges documents 52 in version (initial) clusters 62, such that all the documents in any given cluster 62 are considered likely to be versions of the same document. Different version clusters with similar format and metadata are merged into clusters belonging to the same base type (cluster) 60, such as the type that is later given the label “system sales contracts” in the example shown in FIG. 2. These base clusters are typically the main and most important output of the system. Such base type clusters are later merged into larger clusters belonging to types 58, such as the types later identified as “sales contracts” and “employment contracts.” These type clusters are in turn merged into an even more general cluster, labeled “contracts,” which itself is later merged into the most general cluster, labeled “legal documents.” These document types, the document type hierarchy and the cluster type labels are created automatically by server 22. Hierarchy 50 represents only one simplified example of a hierarchy of this sort that might be created in a typical enterprise.

Users may subsequently search for documents by specifying any of the types in hierarchy 50. A given type and the corresponding cluster may be identified by more than a single name (also referred to as a label), and the user may then indicate the type in the search query by specifying any of the names.

FIG. 3 is a flow chart that schematically illustrates a method for clustering documents by type, in accordance with an embodiment of the present invention. In the description that follows, it is assumed, for clarity of explanation, that the method is carried out by feature extractor 35 and classifier 38 in server 22, but the method is not necessarily tied to this or any other particular architecture. The method is incremental, clustering each new input document according to the existing documents and type clusters. It assigns the new document to an existing type cluster or clusters or creates a new one if the document is too distant from all existing clusters.

Feature extractor 35 analyzes each document retrieved by crawler 34, at a feature extraction step 70, in order to extract various types of features, which typically include content features, format features and metadata features. The content features are a filtered subset of the document tokens (typically words) or sequences of tokens. The format features relate to aspects of the structure of the document, such as layout, outline, headings, and embedded objects, as opposed to the textual content itself. The metadata features are taken from the metadata fields that are associated with each document, such as the file name, author and date or creation and/or modification. The feature extractor processes the content, format and metadata and stores the resulting features in repository 36.

For efficient searching, content features and some metadata features may be represented in terms of tokens, while other features, particularly format features, are represented as a vector of properties. In the token representation, the similarity between documents is evaluated in terms of the number or percentage of tokens in common between the documents. In the vector representation, the similarity between documents depends on the vector distance, which is a function of the number of vector elements that contain the same value in both documents. The term “vector,” as used in the context of the present patent application and in the claims, means an array of elements, each having a specified value. In this context, a vector may be represented by a string, in which each character corresponds to an element, and the value of the element is the character itself.

The values of the vector elements are grouped and normalized for the purpose of this evaluation, as illustrated by the following example of certain format properties:

Given the following vector:

| | | | | Left |
|---|---|---|---|---|
| Size | Length | Font Color | Alignment | indentation |
| 10 | 5 | Blue | 2.4 | True |

The feature extractor first groups the properties:

| | | | Total |
|---|---|---|---|
| Size | Length | Font Color | Alignment |
| 10 | 5 | Blue | Left 2.4 |

It groups the values of each property in a standard representation, with terms represented by alphanumeric symbols:

Size: between 1 . . . 10—term A

Length: between 1 . . . 50—term B1

Font Color Blue—term B2

Total Alignment: between 1 . . . 3—term C

The vector representation is then:

### Vector Terms:

| | | | Total |
|---|---|---|---|
| Size | Length | Font Color | Alignment |
| A | B1 | B2 | C |

As noted above, features that can be efficiently represented and compared in terms of tokens include file names and certain other metadata, keywords and heading text. Features that can be better represented in terms of vectors include document style, heading style, embedded objects, and document structure characteristics. Details of the analysis and classification of some of these features are presented hereinbelow.

After the feature extractor has extracted the desired features of a given input document, classifier 38 uses these features in retrieving similar documents, at a document retrieval step 72. These documents, referred to herein as “candidate documents,” are retrieved from among the documents that were previously processed and type-clustered. They are “candidates” in the sense that they share with the input document certain key features and are therefore likely to be part of the same type cluster or clusters as the input document. To facilitate step 72, feature extractor 35 may create an index of key document features in repository 36 at step 70. Then, for each input document at step 72, classifier 38 searches the key features of the input document in the feature index and finds the indexed documents that share at least one key feature with the input document. This step enables the classifier to efficiently find a relatively small set of candidate documents that have a high likelihood of being in the same type cluster as the input document.

If the classifier finds no candidate documents that are similar to the current input document at step 72, it assigns the input document to a new cluster, at a new cluster definition step 73. Initially, this new cluster contains only the input document itself.

When a set of one or more suitable candidate documents is found at step 72, classifier 38 calculates one or more distance functions for each candidate document in the set, at a distance computation step 74. The distance functions are measures of the difference (or inversely, the similarity) between the candidate document and the input document and may include content feature distance, format feature distance, and metadata feature distance. Alternatively, other suitable groups of distance measures may be computed at this step. If the distance functions are below certain predetermined thresholds for all candidate documents (i.e., large distance between the input document and the candidate documents), the classifier assigns the input document to a new cluster at step 73.

Assuming, however, that one or more sufficiently-close candidates were found at step 74, classifier 38 uses the distance functions in building type clusters and in assigning the input document to the appropriate clusters, at a clustering step 76. After finding the base type clusters in this manner, the classifier creates a type hierarchy by clustering the resulting type clusters into “bigger” (more general) clusters, at a labeling and hierarchy update step 78. The classifier also extracts cluster characteristics and identifies, for each type cluster, one or more possible labels (i.e., cluster names). These aspects of the method, which are described in detail in the above-mentioned U.S. patent application Ser. No. 12/200,272, are beyond the scope of the present patent application.

The following sections of this patent application will describe how server 22 treats certain kinds of features that the inventors have found to be particularly useful in document type classification.

### File Name Feature

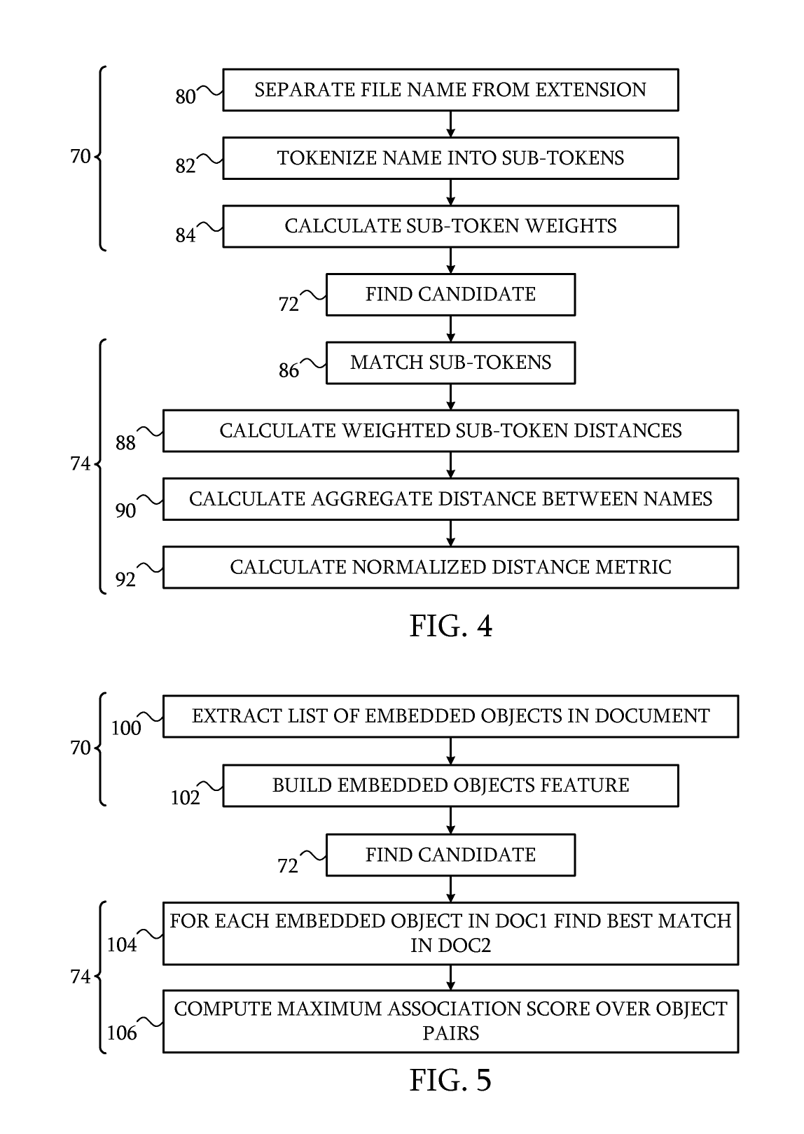

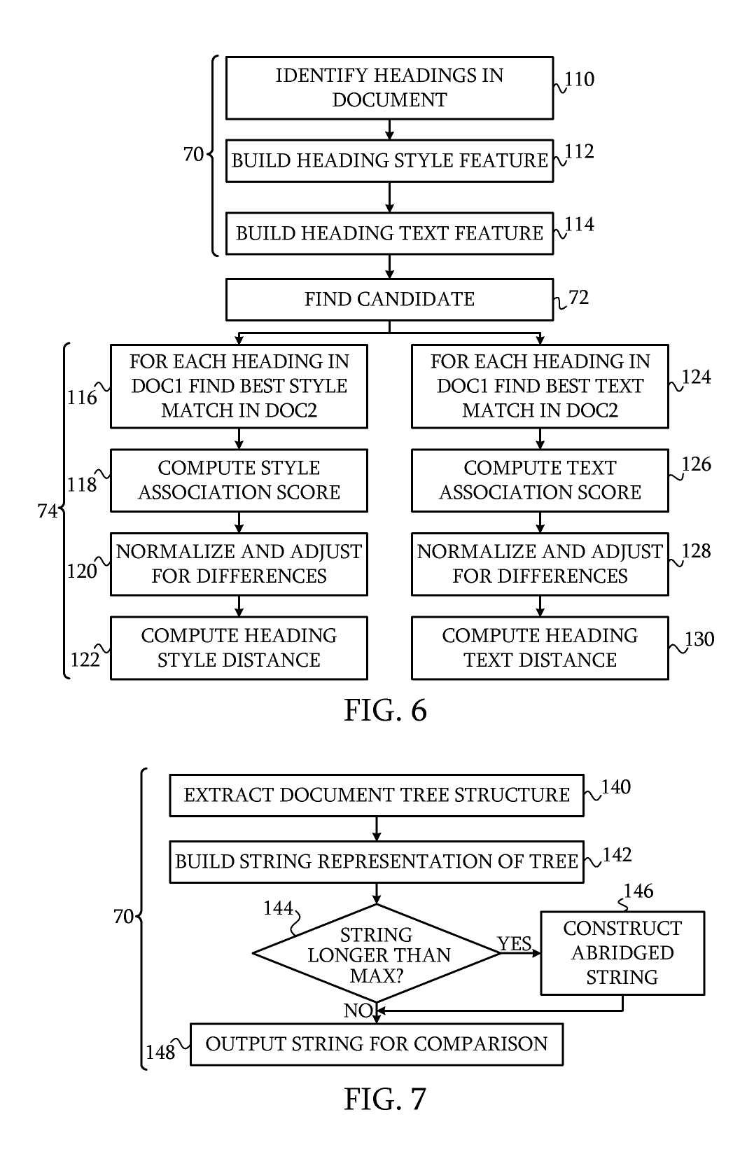

FIG. 4 is a flow chart that schematically illustrates a method for extracting and comparing file name features, in accordance with an embodiment of the present invention. This method is based on the realization that the file names of documents of a given type frequently contain the same sub-strings (referred to hereinbelow as sub-tokens), even if the file names as a whole are different. The steps in this method (as well as those in the figures that follow) are actually sub-steps of the more general method shown in FIG. 3. The correspondence with the steps in the method of FIG. 3 is indicated by the reference numbers at the left side of FIG. 4, as well as in the subsequent figures.

Feature extractor 35 reads the file name of each document that it processes and separates the actual file name from its extension (such as .doc, .pdf, .ppt and so forth), at an extension separation step 80. The extension is the sub-string after the last ‘.’ in the file name, while the name itself is the sub-string up to and including the character before the last ‘.’ of the name. The distances between the names themselves and between the extensions is calculated separately, as detailed below. In addition, if the file name includes a generic prefix, such as “Copy of,” which is added automatically by the Windows® operating system in some circumstances, the feature extractor removes this prefix.

The feature extractor splits the file name into sub-tokens, in a tokenization step 82. Each sub-token is either:
A symbol character (not a letter or a digit), such as “-”.
A consecutive sequence of digits (numeric), such as “235”.
A sequence of alpha (letter) characters, within which the case does not change from lower-case letters to upper-case letters (i.e., a sub-token always ends with a lower-case letter if the next letter is an upper-case letter).
   Thus, for example, the file name “docN396” is split into the sub-tokens: “doc”, “N”, “396”.

The feature extractor then assigns weights to the sub-tokens, at a weight calculation step 84. For this purpose, the feature extractor calculates a non-normalized weight NonNWeight(token) for each sub-token based on its typographical and lexical features. Weights may be assigned to specific features as follows, for example:

| | Token |
|---|---|
| Token feature | Weight |
| Sub-token is the first token and is alpha | 10 |
| (letters) token | |
| Sub-token is the first token and is not an | 1 |
| alpha token | |
| Sub-token is the second token and is an | 4 |
| alpha token | |
| Sub-token is the last token and is an alpha | 5 |
| token | |
| Sub-token is any upper-case token | 1 |
| Sub-token is an acronym | 15 |

The above weights are in addition to a baseline weight of 1 that is given to every sub-token. Additionally or alternatively, weights may be assigned to specific sub-tokens that appear in a predefined lexicon. Further alternatively, any other suitable weight-assignment scheme may be used. Finally, the feature extractor calculates the normalized weight for each sub-token by dividing the non-normalized weight by the sum of all the sub-token weights in the file name.

For example, the following weights will be calculated for the sub-tokens of the file name “xview-datasheet”:
“xview”: minimum 1+10 first token alpha=11
“-”: minimum 1=1
“guide”: minimum 1+5 last token alpha+5 for keyword=11

Sum of total aggregate non-normalized weights:
11+1+11=23

Normalized weights for each sub-token:
“xview”: 11/23=0.478
“-”: 1/23=0.043
“datasheet”: 11/23=0.478

After extracting the features of a given input document, classifier 38 seeks candidate documents that are similar to the input document at step 72, as described above. When a suitable candidate document is found, the classifier compares various features of the input and candidate documents at step 74, including the file name features outlined above. For this purpose, the classifier matches and aligns the sub-tokens in the file names of the input and candidate documents, at a matching step 86. It then calculates weighted distances between the aligned pairs of sub-tokens, at a sub-token distance calculation step 88, and combines the sub-token distances to give an aggregate weighted distance, at an aggregation step 90.

A detailed algorithm for implementing steps 88 and 90 is presented in the following pseudo-code listing:
Let name1, name2 be the file names for which the distance measure is calculated.
Let Count1=number of sub-tokens of name1, Count2=number of tokens of name2.
Assume (without loss of generality) that Count1<=Count2.
Let Weight1[i] be the normalized weight of the i token of name1, Weight2[i] the normalized weight of the i token of name2.
For(i=0;i<Count1;i++)

{

Let Tokens1[i] be the i sub-token of name 1
Let Token2[i] be i sub-token of name 2
Let dist(Token1[i],Token2[i]) be the distance

measure between the two sub-tokens (as
defined below)

weightForToken = Max(Weight1[i],Weight2[i])
weightedDifference += weightForToken * Count1 *

(1− dist(Token1[i],Token2[i]))

}
return weightedDifference

The distance measure between sub-tokens in the above listing may be defined as follows:
Case I: The two sub-tokens are identical (no matter what their content is).
In this case the distance measure is always 1.
Case II: One (or two) of the sub-tokens is an acronym (two- or three-letter upper-case sequence), and the tokens are different.
In this case the distance measure is always 0.
Case III: The two sub-tokens are both members in a lexicon of terms that are semantically closely related (for example: month names—“February” and “June”).
In this case, the distance measure between the sub-tokens is a corresponding value listed in the lexicon.
Case IV: The two sub-tokens t1, t2 are both numbers.
In this case, Distance Measure=(JaroWinkler(t1,t2)+3-Gram(t1,t2)+NumberMeasure(t1,t2))/3
JaroWinkler(t1,t2) is the Jaro-Winkler distance between the sub-tokens,
3-Gram(t1,t2) is the 3-Gram distance between the sub-tokens, and
NumberMeasure(t1,t2)=1−Abs(n1−n2)/Max(n1,n2), wherein n1, n2 are the representations of t1, t2 as an integer numbers.

The 3-Gram distance (or q-gram distance for q=3) is described in detail by Gravano et al., in “Using q-grams in a DBMS for Approximate String Processing,” IEEE Data Engineering Bulletin, 2001 (available at pages.stern.nyu.edu/˜panos/publications/deb-dec2001. pdf). Briefly, a window of length q over the characters of a string is used to create a number of q-grams of length q (here q=3) for matching. A match is then rated according to the number of q-gram matches within the second string over possible q-grams. The 3-gram distance is the proportion of such matches out of the total number of 3-length sequences.
Case V: Otherwise
Distance Measure=jrWeight*JaroWinkler(t1,t2)+(1−jrWeight)*3-Gram(t1,t2)
wherein jrWeight is a weight given to the Jaro-Winkler measure in proportion to the minimal length of the two sub-tokens. Typically, the weight is 0 for short tokens (two characters or less) and grows with token length up to some limit.

The aggregate distance may be computed at step 90 in both forward order of the tokens in the two file names and backward order, i.e., with the order of the sub-tokens reversed. The final aggregate distance (FinalWeightedPenalty) may then be taken as a weighted sum of the forward and backward distances. The weights for this sum are determined heuristically so as to favor the direction that tends to give superior alignment of the sub-tokens.

Classifier 38 computes the final, normalized distance measure between the file names, at a final measure calculation step 92. This measure is a value between 0 and 1, given by the formula:

Normalized measure=Max(0,Count1−FinalWeightedPenalty)/Count1*(Count1+Count2)/(2*Count1)

wherein Count1 is the number of sub-tokens in name1, and Count2 is the number of sub-tokens in name2, assuming that Count1<=Count2. The value of the distance measure may be adjusted when certain special characters (such as “_” or “-”) are present in the file name. Documents with normalized measure values close to 1 are considered likely to belong to the same type. The file name distance measure is used, along with other similarity measures, in assigning the input document to a cluster at step 76 (FIG. 3).

### Embedded Object Feature

FIG. 5 is a flow chart that schematically illustrates a method for extracting and comparing embedded object features, in accordance with an embodiment of the present invention. The inventors have found that documents of the same type frequently have at least one embedded object with similar or identical characteristics, so that embedded object features can be useful in automated document clustering. In preparation for building an embedded objects feature for a given input document, feature extractor 35 first makes a pass over the document in order to identify embedded objects and then creates a list of the embedded objects in the document, at an object extraction step 100. The list indicates certain characteristics, such as the name, type, size, location and dimensions of the embedded objects that have been found.

The feature extractor then builds an embedded objects feature containing the characteristics values of the objects that were found, at a feature building step 102. Typically, a maximum number of embedded objects is specified, such as three, which may be limited to embedded objects of images (rather than other objects). If the input document contains more than this maximum number, the feature extractor may, for example, use only the first embedded object and the last embedded object in the list in making up a feature whose length is no more than the maximum.

After finding a candidate document at step 72, classifier 38 reviews the embedded object features of the input and candidate documents in order to compute an embedded objects feature association score. If the embedded object lists are of different lengths, the shorter list is evaluated against the longer one. For each embedded object on the list being evaluated, the classifier searches for the embedded object on the other list that provides the best match, at an object matching step 104. For an object in position i on the list being evaluated, the search at step 104 may be limited to a certain range of positions around i on the other list (for example, i±2).

To find the best match at step 104, classifier 38 computes an association score between the embedded object that is currently being evaluated and each of the candidate embedded objects on the other list. The score for a given candidate may be incremented, for example, based on similarities in height and width of the embedded objects, as well as on formatting, image content, and image metadata. The candidate that gives the highest association score is chosen as the best match.

After finding the best match and the corresponding association score for each embedded object on the list being evaluated, classifier 38 computes an embedded object association score between the input document and the candidate document, at a score computation step 106. This association score is a measure of the distance between the input and candidate documents in terms of their embedded object features. It may be a weighted sum of the matching pair scores with increasingly higher weights for embedded objects found earlier. Alternatively, the association score may simply be the maximal value of the association score taken over all the matching pairs that were found at step 104. This score is used, along with other similarity measures, in assigning the input document to a cluster at step 76 (FIG. 3).

### Heading Features

FIG. 5 is a flow chart that schematically illustrates a method for extracting and comparing heading features, in accordance with an embodiment of the present invention. The heading features relate both to heading styles, i.e., to the format of the headings, and to heading content, i.e., to the text of the headings. These heading features are a strong indicator of the document format, which unites documents belonging to the same type.

In order to find the heading features, feature extractor 35 first passes over the input document in order to distinguish headings in the document, at a heading identification step 110. These headings may include, for example, separate heading lines, as well as prefixes at the beginnings of lines. Headings are typically characterized by font differences relative to standard paragraphs, such as boldface, italics, underlining, capitals, highlighting, font size, and color, and may thus be identified on this basis. Each possible heading receives a heading score indicating the level of confidence that it is actually a heading, depending on various factors that reflect its separation and distinctness from the surrounding text.

After extracting the headings, feature extractor 35 builds a heading style feature, at a style feature extraction step 112, and a heading text feature, at a text feature extraction step 114. The same general technique may be used to build both features: Maximal and minimal numbers of headings for inclusion in the feature are specified. (For example, the maximal number may be twelve, while the minimal number is one.) If the input document contains more than the maximal number of headings, then a certain fraction of the headings to be included in the heading feature (for example, 75%) are taken from the beginning of the document, and the remainder are taken from the end. The feature extractor passes over the candidate headings starting from the beginning of the document and selects the headings that received a score above a predefined threshold. If the number of headings that are selected in this manner is less than the required fraction of the maximal number (in the above example, less than nine headings), the feature extractor may lower the threshold and repeat the process until it reaches the required number or until there are no more headings to select. The same process is repeated starting from the end of the document, and the heading style and text features are thus completed.

After finding a candidate document at step 72, classifier 38 uses the heading style and heading text features (each of them separately) to compute respective distance measures between the input document and the candidate document. If the heading lists in the documents are of different lengths, the classifier chooses the shorter of the two lists as the evaluated list, to be used as the basis for the herein-described iteration. With regard to the heading style feature, for each heading on the list being evaluated, the classifier finds the heading on the other list that gives the best match, at a heading style matching step 116. The search at this step for a match to a heading in position i on the list being evaluated may be limited to a certain range of positions around i on the other list (for example, i±2). The match is evaluated in terms of an association score that the classifier computes between the pair of headings. The association score for a given pair is incremented for each style similarity between the headings, such as alignment, indentation, line spacing, bullets or numbers, style name, and font characteristics.

After finding the best match for each heading, classifier 38 computes a total style association score, at a score computation step 118. This score may be simply the sum of the association scores of the pairs of headings that were found at step 116. Alternatively, the individual association scores of the heading pairs may be adjusted to reflect the respective heading scores that were computed for each heading at step 112, as explained above. Thus, for example, each association score may be multiplied by the heading score of the evaluated heading in order to give greater weight to headings that have been identified as headings with high confidence.

Classifier 38 normalizes and adjusts the total score, at an adjustments step 120. Several adjustments may be applied: For example, headings near the beginning of the document may receive a higher weight in the total, as may pairs of headings having high confidence levels. If the classifier uses the heading scores to weight the association scores, then it may also keep track of the total of the heading scores and divide the weighted total of the association scores by the total of the heading scores in order to give the normalized heading style distance measure between the documents. On the other hand, if there is a significant difference between the input and candidate documents in terms of the number of headings, the normalized heading style distance measure may be decreased in proportion to the difference in the number of headings.

The classifier computes the heading style distance measure, at a distance computation step 122. This distance measure is equal to the total of the individual heading association scores, with appropriate weighting and adjustment as noted above. For integration with other distance measures, the classifier may limit the heading style distance measure to the range between 0 and 1 by truncating values that are outside the range.

The computation of the heading text distance measure is similar to the style distance computation, except that the contents, rather than the styles, of the headings are considered. For each heading in the feature list for the document being evaluated, classifier 38 finds the heading within a certain positional range on the other list that gives the best text match, at a heading text matching step 124. The match in this case is evaluated in terms of a text association score that the classifier computes between the pair of headings. The association score is calculated by taking a certain predetermined prefix of each heading string (such as the first forty characters, or the entire string if less than forty characters) and measuring the string distance between the two sub-strings. The distance measure used for this purpose is similar to the sub-token distance measures that were defined above for finding file name distances (FIG. 4).

After finding the best text match for each heading, classifier 38 computes a total text association score, at a score computation step 126. This score is computed by summing the individual heading association scores that were computed at step 124. The scores may be weighted to give an additional boost to heading pairs that matched exactly (association score=1). The boost may be proportional to the number of tokens (alpha groups, number groups, or punctuation marks, as defined above) in the headings and specifically to the number of alpha tokens, so that multi-word headings that match exactly receive the greatest weight. In addition, the boost may take into account other features of the heading itself, such as the occurrence of certain indicative keywords within the heading.

Classifier 38 normalizes and adjusts the total heading text score, at an adjustments step 128. If the classifier boosted certain association scores, then it may also keep track of the total of the boost factors and divide the weighted total of the association scores by the total of the boost factors in order to give a normalized heading text distance measure between the documents. If there is a significant difference between the input and candidate documents in terms of the number of headings, the normalized heading text distance measure may be decreased in proportion to the difference in the number of headings.

The classifier computes the heading text distance measure, at a distance computation step 130. This distance is equal to the total of the individual heading association scores, with appropriate weighting and adjustment as noted above. For integration with the other similarity measures, the classifier may limit the distance to the range between 0 and 1 by truncating values that are outside the range.

### Document Structure Feature

FIG. 7 is a flow chart that schematically illustrates a method for extracting and representing document structure features, in accordance with an embodiment of the present invention. The purpose of this method is to capture the structure of each document, in terms of section hierarchy and sequential order, in a simple representation that can be used in finding document similarity. In the present embodiment, the document structure is represented by a single vector (string), in which each section of the document is represented by a certain letter (such as ‘S’), followed by the number of children of the section and its text length, if it is a paragraph. As in the case of the other features described above, the length of the string representing the document structure is limited to a certain maximal number of characters (for example, twenty-five characters). For documents whose structural representation exceeds this limit, feature extractor 35 builds a certain fraction of the string (for example, 70%) starting from the beginning of the document and the remainder from the end of the document.

Feature extractor 35 assumes that a hierarchical representation (tree structure) of the input document is available. The tree structure may be extracted, for example, using a suitable application program interface (API), as is available for many document formats, such as Microsoft Word®. The feature extractor converts the tree structure of into a string as described above, at a string representation generation step 142. The feature extractor traverses the document tree recursively using a pre-order sequence (going from a node itself to its children nodes and then to its siblings if any). For each composite node (i.e., each node having one or more children), the feature extractor performs the following steps to build the document structure string for that node:

1. Identify the node type (Section, Shape, Row or Run) and create the suitable one-letter encoding for that type (‘D’ for document, ‘B’ for body, ‘S’ for section, ‘P’ for paragraph, ‘H’ for header or footer, ‘O’ for shape, ‘G’ for GroupShape, ‘R’ for run (a sub-part of a paragraph with a distinctive style), ‘T’ for table, ‘W’ for row, ‘C’ for cell, ‘Z’ for other node type).
2. Concatenate to the node type encoding the digit indicating the number of children of the node. (If the number of children is 10 or higher, only the first digit is used.)
3. If the node type is paragraph, concatenate to the above the first digit of the paragraph character length.

For example, the string generated for a simple document with one section including two paragraphs with the same style (one run per paragraph) may be DS2P6RP7R.

Feature extractor 35 compares the length of the string generated at step 142 to a predetermined maximum vector length, at a length evaluation step 144. If the string is longer than the maximum, the feature extractor truncates it, as noted above, by selecting a sequence containing a certain number of characters from the beginning of the string and concatenating it with another sequence from the end of the string to give an abridged output string of the required length, at an abridgement step 146. The final output string is saved for subsequent document comparison, at a string output step 148.

When comparing documents at step 74 (FIG. 3), classifier 38 computes the string distance between the document structure strings of the two documents. Any suitable string distance measure may be used at this step, such as the Jaro-Winkler distance. The distance measure may be normalized to the range 0-1, like the other distance measures described above, with the value “1” assigned to documents that are structurally identical and “0” to documents with no structural similarity.

### Document Pre-Processing Steps

As a precursor to the feature extraction steps described above, feature extractor 35 pre-processes the input document. As noted earlier, the feature extractor extracts the hierarchical (tree) structure of the document, typically using available APIs, such as those provided by Aspose (Lane Cove, NSW, Australia). The resulting tree representation is used as the input for the heading, embedded object, and document structure features described above. For this purpose, after the tree structure is extracted, the feature extractor separates any paragraph prefixes (suspected to be headings) from the respective paragraphs and identifies the baseline conventions of the paragraph style, i.e., the style conventions that appear most frequently in the document. The feature extractor arranges the document heading-paragraphs and embedded objects as lists, which are later used to build the above-mentioned features

The inventors have found that the combination of the various distance measures described above gives a reliable representation of document type, i.e., it enables classifier 38 to automatically group documents by type in a way that mimics successfully the grouping that would be implemented by a human reader. Alternatively, the distance measures described above may be used individually or in various sub-combinations, and they may similarly be combined with other measures of document similarity. Some other measures of this sort, as well as detailed techniques for grouping documents using such measures, are described in the above-mentioned U.S. patent application Ser. No. 12/200,272.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for document management, the method comprising:
automatically extracting respective features from each of a set of documents;
processing the features in a computer so as to generate respective vectors for the documents, each vector comprising elements having respective values that represent properties of a respective document;
assessing a similarity between the documents by computing a measure of distance between the respective vectors; and
automatically clustering the documents responsively to the similarity so as to identify a cluster of the documents belonging to a common document type.

2. The method according to claim 1, wherein processing the features comprises generating a string corresponding to the vector, and wherein the elements of the vector comprise respective characters in the string.

3. The method according to claim 2, wherein automatically extracting the respective features comprises parsing a hierarchical tree representation of each of the documents, and building the string to represent the tree by recursively traversing the nodes of the tree and adding the characters to the string so as to represent the traversed nodes.

4. The method according to claim 2, wherein generating the string comprises, when the string exceeds a predetermined length, truncating the string to the predetermined length by selecting a first sequence of the characters from a beginning of the string and concatenating it with a second sequence of the characters from an end of the string.

5. The method according to claim 2, wherein computing the measure of distance comprises computing a string distance between strings representing the respective vectors.

6. The method according to claim 1, wherein at least some of the elements of the vectors comprise symbols that represent respective ranges of values of the properties.

7. The method according to claim 1, wherein automatically extracting the respective features comprises identifying format features of the documents, and wherein the elements of the vectors represent respective characteristics of the format.

8. A method for document management, the method comprising:
receiving respective file names of a plurality of documents;
processing each file name in a computer so as to divide the file name into a sequence of sub-tokens;
assigning respective weights to the sub-tokens;
assessing a similarity between the documents by computing a measure of distance between the respective file names based on the sub-tokens in each of the file names and on the respective weights of the sub-tokens; and
automatically clustering the documents responsively to the similarity so as to identify at least one cluster of the documents belonging to a common document type.

9. The method according to claim 8, wherein processing each file name comprises separating the file name into alpha, numeric, and symbol sub-tokens.

10. The method according to claim 9, wherein each alpha sub-token consists of a sequence of letters, each having a respective case, such that the case does not change from lower case to upper case within the sequence.

11. The method according to claim 9, wherein assigning the respective weights comprises assigning a greater weight to the alpha sub-tokens than to the numeric and symbol sub-tokens.

12. The method according to claim 8, wherein assigning the respective weights comprises assigning a greater weight to acronyms than to other sub-tokens.

13. The method according to claim 8, wherein computing the measure of the distance comprises computing a weighted sum of sub-token distances between the sub-tokens of a first document and corresponding sub-tokens of a second document, wherein the sub-token distances are weighted by the respective weights of the sub-tokens.

14. The method according to claim 13, wherein computing the weighted sum comprises aligning each of the sub-tokens of the first document with a first corresponding sub-token of the second document in a forward order in order to compute a first weighted distance, and aligning each of the sub-tokens of the first document with a second corresponding sub-token of the second document in a reverse order in order to compute a second weighted distance, and combining the first and second weighted distances in order to find the measure of the distance between the respective file names.

15. A method for document management, the method comprising:
automatically identifying respective embedded objects in each of a set of documents;
processing the embedded objects in a computer so as to extract respective embedded object features of the documents, wherein the embedded object features are indicative of format characteristics of the embedded objects in the documents;
assessing a similarity between the documents by computing a measure of distance between the documents based on the respective embedded object features; and
automatically clustering the documents responsively to the similarity so as to identify a cluster of the documents belonging to a common document type.

16. The method according to claim 15, wherein the embedded object features comprise a respective shape of each of the embedded objects.

17. The method according to claim 15, wherein computing the measure of the distance comprises aligning each of the embedded objects in a first document with a corresponding embedded object in a second document, and computing an association score between the aligned embedded objects.

18. A method for document management, the method comprising:
automatically extracting headings from each of a set of documents;
processing the headings in a computer so as to generate respective heading features of the documents;
assessing a similarity between the documents by computing a measure of distance between the documents based on the respective heading features; and
automatically clustering the documents responsively to the similarity so as to identify a cluster of the documents belonging to a common document type.

19. The method according to claim 18, wherein automatically extracting the headings comprises distinguishing the headings from paragraphs of text with which the headings are associated in the documents.

20. The method according to claim 19, wherein distinguishing the headings comprises assigning respective heading scores to the headings, indicating a respective level of confidence in each of the headings, and wherein processing the headings comprises choosing the headings for inclusion in the heading features responsively to the respective heading scores.

21. The method according to claim 20, wherein computing the measure comprises computing a weighted sum of association scores between the headings, weighted by the heading scores.

22. The method according to claim 18, wherein processing the headings comprises extracting format characteristics of the headings, and generating a heading style feature based on the format characteristics.

23. The method according to claim 18, wherein processing the headings comprises extracting textual content from the headings, and generating a heading text feature based on the textual content.

24. The method according to claim 23, wherein computing the measure of the distance comprises computing a heading text distance responsively to the textual content and computing a heading style distance responsively to format characteristics of the headings.

25. The method according to claim 18, wherein computing the measure of the distance comprises aligning each of the headings in a first document with a corresponding heading in a second document, and computing an association score between the aligned headings.

26. A computer software product, comprising a computer-readable medium in which program instructions are stored, which instructions, when read by a computer, cause the computer to extract respective features from each of a set of documents, to process the features so as to generate respective vectors for the documents, each vector comprising elements having respective values that represent properties of a respective document, to assess a similarity between the documents by computing a measure of distance between the respective vectors, and to cluster the documents responsively to the similarity so as to identify a cluster of the documents belonging to a common document type.

27. A computer software product, comprising a computer-readable medium in which program instructions are stored, which instructions, when read by a computer, cause the computer to receive respective file names of a plurality of documents, to process each file name so as to divide the file name into a sequence of sub-tokens, to assign respective weights to the sub-tokens, to assess a similarity between the documents by computing a measure of distance between the respective file names based on the sub-tokens in each of the file names and on the respective weights of the sub-tokens, and to cluster the documents responsively to the similarity so as to identify at least one cluster of the documents belonging to a common document type.

28. A computer software product, comprising a computer-readable medium in which program instructions are stored, which instructions, when read by a computer, cause the computer to identify respective embedded objects in each of a set of documents, to process the embedded objects so as to extract respective embedded object features of the documents, wherein the embedded object features are indicative of format characteristics of the embedded objects in the documents, to assess a similarity between the documents by computing a measure of distance between the documents based on the respective embedded object features, and to cluster the documents responsively to the similarity so as to identify a cluster of the documents belonging to a common document type.

29. A computer software product, comprising a computer-readable medium in which program instructions are stored, which instructions, when read by a computer, cause the computer to extract headings from each of a set of the documents, to process the headings so as to generate respective heading features of the documents, to assess a similarity between the documents by computing a measure of distance between the documents based on the respective heading features, and to cluster the documents responsively to the similarity so as to identify a cluster of the documents belonging to a common document type.

30. A method for document management, the method comprising:
providing respective training sets comprising known documents belonging to each of a plurality of document types;
automatically extracting respective features from the known documents and from each of a set of new documents;
processing the features in a computer so as to generate respective vectors for the documents, each vector comprising elements having respective values that represent properties of a respective document;
assessing a similarity between the new documents and the known documents in each of the training sets by computing a measure of distance between the respective vectors; and
automatically categorizing the new documents with respect to the document types responsively to the similarity.
